(19) United States
(12) Patent Application Publication
(10) Pub. No.: US 2022/0301400 A1
(43) Pub. Date: Sep. 22, 2022

(54) SYMBOL READING DEVICE AND METHOD

(71) Applicant: TOSHIBA TEC KABUSHIKI KAISHA, Tokyo (JP)

(72) Inventor: Takuya Takasu, Shizuoka Shizuoka (JP)

(21) Appl. No.: 17/537,547

(22) Filed: Nov. 30, 2021

(30) Foreign Application Priority Data
Mar. 18, 2021 (JP) 2021-045080

(51) Int. Cl. G07G 1/00; H04N 5/235; G06K 7/14

(52) U.S. Cl. CPC G07G 1/0045; H04N 5/2351; H04N 5/2352; G06K 7/146; G06K 7/1413

(57) ABSTRACT

Provided is a symbol reading device and a method capable of efficiently reading a symbol displayed on a paper medium and a display screen. The symbol reading device according to an embodiment includes: an image capturing unit; an illuminating unit configured to illuminate an image capturing region of the image capturing unit; a detecting unit configured to detect whether an object as an image capturing target is a non-light emitting medium or a light emitting medium based on an image captured by the image capturing unit; an illumination control unit configured to control an operation of the illuminating unit according to a detection result of the detecting unit; and a reading unit configured to read a symbol from the image captured by the image capturing unit.

### CROSS-REFERENCE TO RELATED APPLICATION

This application is based upon and claims the benefit of priority from Japanese Patent Application No. 2021-045080, filed on Mar. 18, 2021, the entire contents of which are incorporated herein by reference.

### FIELD

Embodiments described herein relate to a symbol reading device and a method.

### BACKGROUND

In the related art, there is a symbol reading device that reads a barcode, a two-dimensional code or the like (symbol) printed on a paper medium or a symbol displayed on a display screen of, for example, a mobile terminal. In such a symbol reading device, light is emitted from the outside in order to read the symbol printed on the paper medium.

When the symbol displayed on the display screen of, for example, the mobile terminal is read, since the display screen itself emits light, if light is emitted from the outside, the light may be reflected on glass on the surface of the display screen or the like, and there is a possibility that the symbol may not be read.

Therefore, in order to be capable of reading the symbols displayed on the paper medium and the display screen, a technique for controlling a camera and illumination is provided so as to repeat a state where an image capturing timing of the camera and a turn-on timing of the illumination are synchronized and a state where the image capturing timing and the turn-on timing are not synchronized at regular intervals.

However, in the related art, for example, when the symbol displayed on the display screen is read, if the device does not wait until the image capturing timing of the camera and the turn-on timing of the illumination are not synchronized, there is a possibility that the symbol may not be read well. Therefore, there is still room for improvement in terms of symbol reading efficiency.

### DESCRIPTION OF THE DRAWINGS

FIG. 1 is a perspective view showing an overall configuration of a POS system according to an embodiment;

FIG. 2 is a diagram for illustrating an example of a configuration of a reading device according to the embodiment;

FIG. 3 is a diagram showing an example of a hardware configuration of the reading device according to the embodiment;

FIG. 4 is a diagram showing an example of functional components of the reading device according to the embodiment;

FIG. 5 is an explanatory diagram showing an example of a detection process of an object according to the embodiment; and

FIG. 6 is a diagram showing an example of a process of the reading device.

### DETAILED DESCRIPTION

In general, according to one embodiment, a symbol reading device and a method capable of efficiently reading a symbol displayed on a paper medium and a display screen are provided.

A symbol reading device according to an embodiment includes: an image capturing unit; an illuminating unit configured to illuminate an image capturing region of the image capturing unit; a detecting unit configured to detect whether an object as an image capturing target is a non-light emitting medium or a light emitting medium based on an image captured by the image capturing unit; an illumination control unit configured to control an operation of the illuminating unit according to a detection result of the detecting unit; and a reading unit configured to read a symbol from the image captured by the image capturing unit.

Hereinafter, a symbol reading device and a method according to an embodiment will be described. The embodiment below will describe an example of application to a point of sales (POS) system installed in a retail store, but the disclosure is not limited to this embodiment.

(Overall Configuration of POS System)

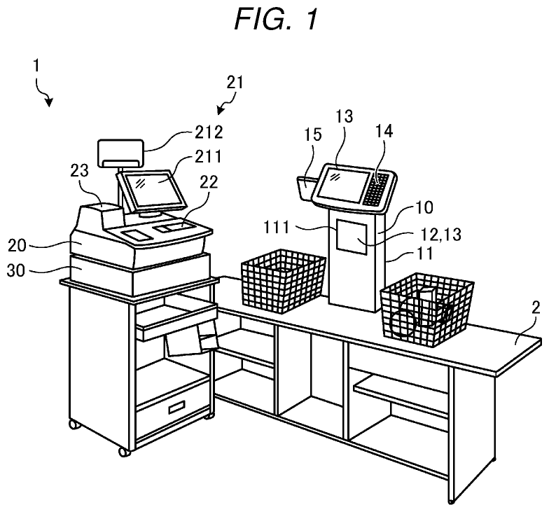

FIG. 1 is a perspective view showing an overall configuration of a point of sales (POS) system 1. The POS system 1 includes a reading device 10 and a POS terminal 20 that executes a data process based on data read by the reading device 10. The reading device 10 is an example of the “symbol reading device”.

The reading device 10 is provided on a sacker table 2 for placing a shopping basket containing products and the like at a position (substantially central portion) where an operator and a customer substantially stand in a face to face manner. The POS terminal 20 is provided nearby one end of the sacker table 2. The reading device 10 and the POS terminal 20 are communicably connected by a transmission line which is not shown. The reading device 10 and the POS terminal 20 configure the POS system 1.

The POS terminal 20 executes a sales data process including a registration process and a settlement process of products purchased by the customer based on data of the products and the like read by the reading device 10. The POS terminal 20 is arranged on a drawer 30 which stores coins and banknotes in such a manner that the money can be taken out from or put in the drawer freely. The POS terminal 20 includes two displays 21 (211 and 212) used for the operator and the customer, an input device 22 including a keyboard and a mode key, and a receipt printer 23.

(Configuration of Reading Device)

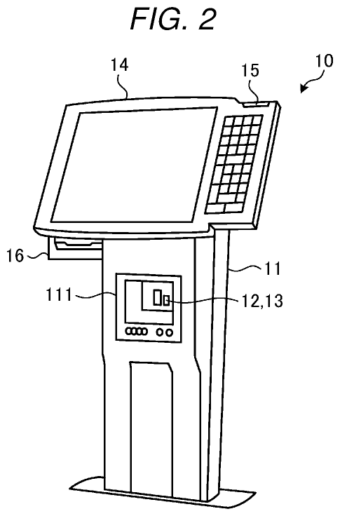

Next, a configuration of the reading device 10 will be described. FIG. 2 is a diagram for illustrating an example of a configuration of the reading device 10. Here, FIG. 2 shows a state that the reading device 10 is viewed from a side on which an image capturing window 111 is provided (a standing position side of the operator).

The reading device 10 includes a main body 11, an image capturing unit 12, an illuminating unit 13, a first display unit 14, a keyboard 15, a second display unit 16 and the like.

The main body 11 is formed in a substantially rectangular parallelepiped shape and is provided on the sacker table 2. The height of the main body 11 on the sacker table 2 is, for example, preferred to be as high as the eyes of the operator.

The image capturing window 111 serving as an opening is provided on the standing position side of the operator at the main body 11. The image capturing unit 12 and the illuminating unit 13 are provided inside the image capturing window 111. The operator holds a product brought by a customer to the image capturing window 111 and then reads (captures) the product.

The image capturing unit 12 includes an image capturing element such as a charge coupled device (CCD) or a complementary MOS (CMOS) and an image capturing lens. The image capturing lens captures an image of an image capturing region on the image capturing element. The image capturing region refers to a region where an image is captured at an area of the image capturing element through the image capturing lens from the image capturing window 111.

The image capturing unit 12 captures an image of the outside of the main body portion 11 through the image capturing window 111. For example, the image capturing unit 12 optically captures an image of a barcode, a two-dimensional code or the like printed on a paper medium. The barcode, the two-dimensional code or the like is an example of the “symbol”, and the paper medium is an example of a non-light emitting medium. Hereinafter, the barcode, the two-dimensional code or the like is simply referred to as the “symbol”.

In addition, for example, the image capturing unit 12 optically captures an image of a symbol displayed on a display screen of a mobile terminal or the like owned by a customer. The display screen of the mobile terminal or the like is, for example, a liquid crystal display (LCD), and a display content is visible when the display screen is illuminated by a light emitting unit such as a backlight. That is, the display screen is an example of the light emitting medium. The display screen may be an organic light emitting diode (OLED) display whose display screen itself emits light.

Here, a symbol printed on a paper medium is assumed to be held in a state that data such as a product identifier (product code) and a price are encoded in the symbol.

Further, a symbol displayed on a display screen is assumed to be held, for example, in a state that data representing a price-cut, a discount coupon or the like is encoded in the symbol. The POS terminal 20 executes a process such as the price-cut or discount based on the data when data representing a coupon or the like is read by the reading device 10.

The illuminating unit 13 has a light source. The light source of the illuminating unit 13 is arranged, for example, around the image capturing lens of the image capturing unit 12. The illuminating unit 13 irradiates the image capturing region of the image capturing unit 12 with light by turning on the light source. The light source is, for example, an LED, a cold cathode tube, a fluorescent lamp, an incandescent lamp or the like.

The first display unit 14 is a display apparatus for an operator and is provided above the image capturing window 111. The first display unit 14 is a display apparatus with a touch panel which is constituted of a display device such as an LCD. The first display unit 14 displays a trade name, a price and the like of a registered product to the operator in response to a sales registration process by the POS terminal 20.

The keyboard 15 is provided in the vicinity (side portion) of the first display unit 14. The keyboard 15 includes various keys used for registering a product that cannot be registered with a symbol or an object image, and the like. Although FIG. 2 shows an example in which the first display unit 14 and the keyboard 15 are integrally provided, the first display unit and the keyboard may be separate bodies.

The second display unit 16 is a display apparatus with a touch panel which is constituted of a display device such as an LCD. The second display unit 16 displays a trade name, a price and the like of a registered product to the customer in response to the sales registration process by the POS terminal 20. In the embodiment, although a configuration in which the second display unit 16 is held on the side portion of the main body 11 by a holding member not shown is used, the disclosure is not limited to this configuration.

(Hardware Configuration of Reading Device)

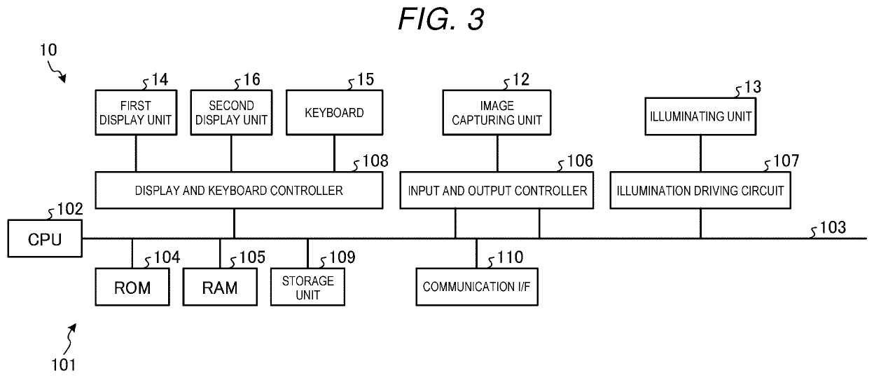

Next, a hardware configuration of the reading device 10 will be described. FIG. 3 is a diagram showing an example of the hardware configuration of the reading device 10. The reading device 10 includes a microcomputer 101. The microcomputer 101 drives and controls each unit of the reading device 10.

The microcomputer 101 includes a CPU 102, a ROM 104, a RAM 105, an input and output controller 106, an illumination driving circuit 107, a display and keyboard controller 108, a storage unit 109, and a communication interface 110. The constituent elements are connected via a bus line 103.

The central processing unit (CPU) 102 centrally controls each unit. The read only memory (ROM) 104 stores fixed information such as a control program or the like in advance. The random access memory (RAM) 105 stores various data in a rewritable manner and functions as a work area or the like.

Therefore, the microcomputer 101 constitutes an information processing unit that executes an information process. All or part of the RAM 105 is a non-volatile memory.

The input and output controller 106 is connected to the image capturing unit 12. The input and output controller 106 outputs an image (image data) captured by the image capturing unit 12 to the microcomputer 101. Further, the input and output controller 106 outputs a control signal received from the microcomputer 101 to the image capturing unit 12.

The illumination driving circuit 107 is connected to the illuminating unit 13. The illumination driving circuit 107 controls the turning on and off of the light source of the illuminating unit 13 under the control of the CPU 102.

The display and keyboard controller 108 drives and controls the first display unit 14 and the second display unit 16, and displays various images on the display 21. Further, the display and keyboard controller 108 outputs an operation signal accompanying a touch operation on the first display unit 14 and the second display unit 16 and an operation signal from the keyboard 15 to the microcomputer 101.

The storage unit 109 is a storage device such as a hard disk drive (HDD) or a solid state drive (SSD). The storage unit 109 stores various programs and various data related to an operation of the reading device 10. The communication interface 110 enables data communication with another device (POS terminal 20) via a connection line such as a LAN cable.

(Function of Reading Device)

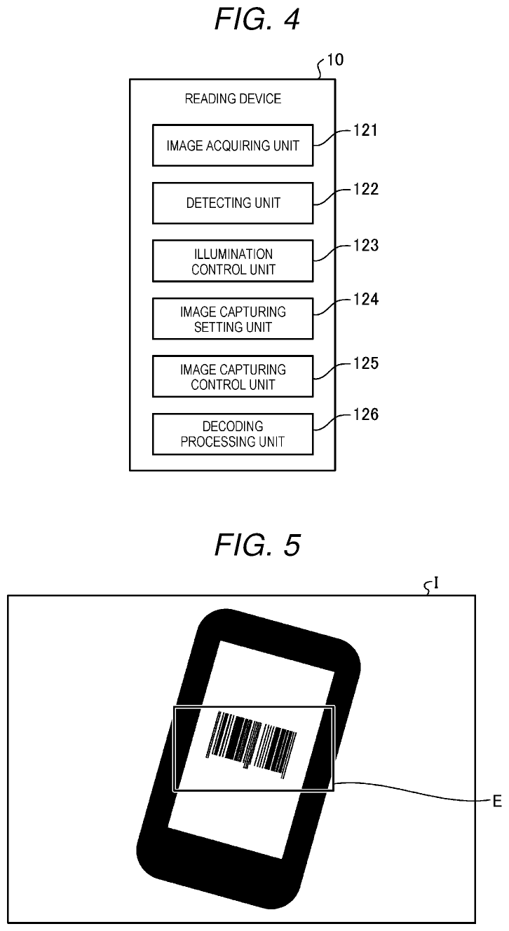

Next, functional components of the reading device 10 will be described with reference to FIG. 4. FIG. 4 is a diagram showing an example of the functional components of the reading device 10. The reading device 10 includes an image acquiring unit 121, a detecting unit 122, an illumination control unit 123, an image capturing setting unit 124, an image capturing control unit 125, and a decoding processing unit 126 as functional components.

More particularly, the reading device 10 includes the functional components as a software configuration in cooperation with the CPU 102 and the program stored in the storage unit 109. A part or all of the functional components may be implemented by a hardware configuration of the CPU 102 or a dedicated circuit or the like.

The image acquiring unit 121 acquires an image captured by the image capturing unit 12. Specifically, the image acquiring unit 121 starts capturing the image data captured by the image capturing unit 12 via the input and output controller 106 if a transaction initiation is instructed by an operation via the keyboard 15 or the first display unit 14, or a signal notified from the POS terminal 20.

Further, the image acquiring unit 121 captures image data used for detecting whether the object is a paper medium or a display screen (hereinafter, referred to as an image for detection). Further, the image acquiring unit 121 captures image data used for reading a symbol (hereinafter, referred to as an image for read).

Specifically, the image acquiring unit 121 captures image data including information for which an image capturing setting is finished as the image for read, and captures other image data as the image for detection. The information for which the image capturing setting is finished will be described below.

Further, the image acquiring unit 121 stops capturing the image data if a transaction termination is instructed by an operation of the keyboard 15 or the first display unit 14, or a signal notified from the POS terminal 20.

The detecting unit 122 detects whether an object as an image capturing target by the image capturing unit 12 is a paper medium or a display screen. For example, the detecting unit 122 detects whether the object is a paper medium or a display screen based on the image for detection acquired by the image acquiring unit 121.

Specifically, the detecting unit 122 detects an emission intensity indicating an intensity of emission of an object according to brightness of a predetermined region in the image for detection. Therefore, whether the object is a paper medium or a display screen can be detected. The detecting unit 122 may only detect whether the object is a paper medium or a display screen.

Hereinafter, a detection process of an object will be described in detail with reference to FIG. 5. FIG. 5 is an explanatory diagram showing an example of the detection process of an object. First, the image acquiring unit 121 acquires an image for detection I captured by the image capturing unit 12. The detecting unit 122 detects a pixel with the highest brightness value in a predetermined detection region E.

In this example, the detection region E is a region of a given range including the center of the image for detection I. Although the detection region E can be set optionally, in general, an object is often held nearby the center of the image capturing window 111, and thus the detection region is preferably set to include the center of the image for detection I.

The detecting unit 122 detects the emission intensity of the object according to the brightness value of the pixel having the highest brightness value in the detection region E. When detecting whether the object is a paper medium or a display screen, for example, a threshold value of the emission intensity is set in advance, the detecting unit 122 detects that the object is a paper medium when the emission intensity is less than the threshold value, and detects that the object is a display screen when the emission intensity is equal to or greater than the threshold value.

Further, the detecting unit 122 may detect the emission intensity of the object according to an average value of the brightness values of pixels in the detection region E. In addition, the detecting unit 122 may extract a part of the pixels in the detection region E, and detect the emission intensity of the object according to the average value of the brightness values of the extracted pixels. In this case, the detecting unit 122 extracts, for example, pixels whose brightness value is in the top 10% among the pixels in the detection region E.

Description will be made again with reference to FIG. 4. The illumination control unit 123 controls a light irradiation operation (mode) by the illuminating unit 13 according to a detection result of the detecting unit 122. For example, when the object is a paper medium, the illumination control unit 123 operates the illuminating unit 13 in a first mode of irradiating the object with light. Further, when the object is a display screen, the illumination control unit 123 operates the illuminating unit 13 in a second mode in which a light amount of the light to be emitted is lower than that of the first mode.

In the embodiment, the illumination control unit 123 controls the turning on and off of the light source of the illuminating unit 13 via the illumination driving circuit 107. Specifically, the illumination control unit 123 turns on the light source of the illuminating unit 13, and controls to irradiate the object with light when a user holds the object in front of the image capturing window 111. Therefore, the image capturing unit 12 can capture an image of the object in the first mode in which the object is irradiated with light.

In addition, the illumination control unit 123 turns off the light source of the illuminating unit 13, and controls to not irradiate the object with light when the user holds the object in front of the image capturing window 111. Therefore, the image capturing unit 12 can capture an image of the object in the second mode in which the object is not irradiated with light.

In addition, the illumination control unit 123 may perform control to adjust the intensity of the light with which the object is irradiated according to the emission intensity detected by the detecting unit 122. In this case, the illumination control unit 123 performs control to reduce the intensity of the light with which the object is irradiated as the emission intensity of the object becomes stronger.

Here, in the embodiment, the first mode functions as a mode used for reading a symbol printed on a paper medium, and the second mode functions as a mode used for reading a symbol displayed on a display screen.

Further, the illumination control unit 123 controls the illuminating unit 13 to be the second mode when the decoding processing unit 126 described later completes a decoding process. In other words, the image capturing unit 12 captures an image for detection in the second mode.

Further, the illumination control unit 123 may operate the illuminating unit 13 in the first mode when the decoding processing unit 126 completes the decoding process. However, as described above, if an image of the display screen is captured in the first mode, light is reflected and the brightness may not be detected correctly, and thus the illumination control unit 123 preferably controls the illuminating unit 13 to be the second mode after the decoding processing unit 126 completes the decoding process.

The image capturing setting unit 124 changes a setting of the image capturing unit 12 according to the emission intensity detected by the detecting unit 122. For example, the image capturing setting unit 124 changes again of the image capturing unit 12, which is one of the settings of the image capturing unit 12, according to the emission intensity detected by the detecting unit 122. In addition, the image capturing setting unit 124 changes a shutter speed of the image capturing unit 12, which is one of the settings of the image capturing unit 12, according to the emission intensity detected by the detecting unit 122.

Specifically, the image capturing setting unit 124 sets the gain of the image capturing unit 12 such that the gain of the image capturing unit 12 decreases as the emission intensity of the object becomes stronger. Generally, when the light amount is small, the sensitivity of image capturing is increased (the gain is increased), and when the light amount is large, the sensitivity of image capturing is reduced (the gain is reduced).

Therefore, the gain is adjusted so that the sensitivity is suitable for the emission intensity of the object by performing the above process, and an image of the object can be captured.

Further, the image capturing setting unit 124 sets the shutter speed of the image capturing unit 12 such that the stronger the emission intensity of the object, the faster the shutter speed of the image capturing unit 12. If the shutter speed is increased, the light amount of light taken in during exposure is reduced, and if the shutter speed is slowed, the amount of light taken in is increased. Therefore, generally, when the light amount is small, the shutter speed is reduced, and when the light amount is large, the shutter speed is increased.

Therefore, the shutter speed is adjusted so that the light amount during the image capturing is suitable for the emission intensity of the object by performing the above process, and an image of the object can be captured.

In addition, the image capturing setting unit 124 may only perform a process that sets the gain of the image capturing unit 12 such that the gain of the image capturing unit 12 decreases as the emission intensity of the object becomes stronger. Further, the image capturing setting unit 124 may only perform a process that sets the shutter speed of the image capturing unit 12 such that the stronger the emission intensity of the object, the faster the shutter speed of the image capturing unit 12.

Further, when the decoding processing unit 126 described later completes the decoding process, the image capturing setting unit 124 changes the settings of the image capturing unit 12 to predetermined basic settings. In other words, the image capturing unit 12 captures an image for detection according to the basic settings.

Further, although the basic settings can be set freely, when the illuminating unit 13 is in the second mode, the exposure may be insufficient when an image of a paper medium is captured, and thus it is preferable that the gain is high and the shutter speed is slow.

The image capturing control unit 125 controls the image capturing unit 12 to capture an image of an object. The image capturing control unit 125 performs control to change the settings of the image capturing unit 12 according to the emission intensity detected by the detecting unit 122 to capture an image of the object, for example.

Specifically, before the image capturing setting unit 124 sets the image capturing unit 12, the image capturing control unit 125 controls the image capturing unit 12 according to the basic settings to capture an image of the object. Further, after the image capturing setting unit 124 sets the image capturing unit 12, the image capturing control unit 125 controls the image capturing unit 12 according to the settings of the image capturing unit 12 set by the image capturing setting unit 124 to capture an image of the object.

Further, the image capturing control unit 125 performs a process that adds the information for which an image capturing setting is finished to image data captured by the image capturing unit 12 during a period from a time when the image capturing setting unit 124 sets the image capturing unit 12 to a time when the decoding processing unit 126 completes the decoding process. Therefore, the image acquiring unit 121 can distinguish and acquire the image for detection and the image for read.

The decoding processing unit 126 retrieves information by decoding the encoded information. Specifically, the decoding processing unit 126 executes a process for detecting a region representing a symbol from an image for read acquired by the image acquiring unit 121 and decoding encoded data held in the symbol.

Further, the decoding processing unit 126 outputs data retrieved by decoding the encoded data held by the symbol to the POS terminal 20 or the like.

(Process of Reading Device)

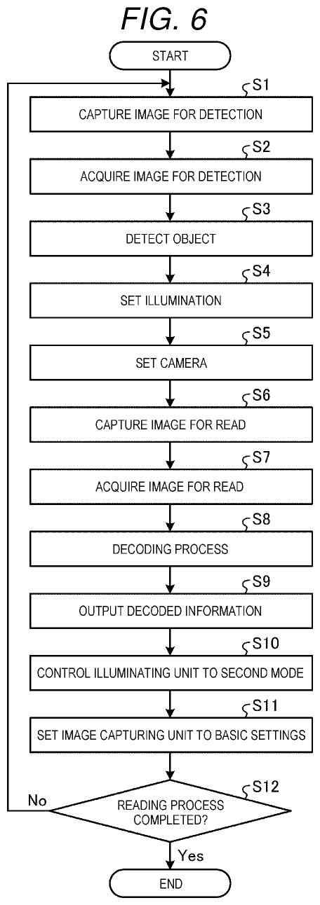

Next, a process of the reading device 10 will be described. FIG. 6 is a flowchart showing an example of the process of the reading device.

First, the image capturing control unit 125 controls the image capturing unit 12 according to the basic settings and captures an image for detection of an object (ACT 1).

Next, the image acquiring unit 121 acquires the image for detection (ACT 2).

Then, the detecting unit 122 detects an emission intensity of the object (ACT 3). Further, the detecting unit 122 detects whether the object is a paper medium or a display screen.

Next, the illumination control unit 123 controls an operation of the illuminating unit 13 according to a detection result of ACT 3 (ACT 4). Specifically, the illumination control unit 123 sets the illuminating unit 13 to the first mode when the object is a paper medium, and sets the illuminating unit 13 to the second mode when the object is a display screen of a mobile terminal or the like.

Next, the image capturing setting unit 124 changes the settings of the image capturing unit 12 according to the emission intensity of the object detected by the detecting unit 122 (ACT 5). Specifically, the image capturing setting unit 124 sets the gain of the image capturing unit 12 such that the gain decreases as the emission intensity of the object becomes stronger. Further, the shutter speed is set such that the stronger the emission intensity of the object, the faster the shutter speed.

Next, the image capturing control unit 125 controls the image capturing unit 12 according to the settings of the image capturing setting unit 124, and captures an image for read of the object (ACT 6).

Then, the image acquiring unit 121 acquires the image for read (ACT 7).

Next, the decoding processing unit 126 executes a decoding process of a symbol based on the image for read acquired by the image acquiring unit 121 (ACT 8).

When the decoding process is completed, the illumination control unit 123 controls the illuminating unit 13 to the second mode (ACT 9).

Next, the image capturing setting unit 124 changes the settings of the image capturing unit 12 to the basic settings (ACT 10).

Next, the decoding processing unit 126 outputs decoded data to the POS terminal 20 (ACT 11).

Next, the image capturing control unit 125 determines whether to complete the reading process (ACT 12). For example, the image capturing control unit 125 determines to complete the reading process when the transaction termination is instructed by the operation of the keyboard 15 or the first display unit 14, or the signal notified from the POS terminal 20.

When it is determined that the reading process is not completed (ACT 12: No), the process proceeds to ACT 1. On the other hand, when it is determined that the reading process is completed (ACT 12: Yes), the process ends.

(Effects of Reading Device)

The reading device 10 according to the embodiment detects whether the object is a paper medium or a display screen, and controls the emission of light by the illuminating unit 13 to the first mode of irradiating the object with light when the object is a paper medium, and controls the emission of light to the second mode of not irradiating the object with light when the object is detected as a display screen.

Therefore, the reading device 10 according to the embodiment can dynamically switch the emission of light by the illuminating unit 13 according to the detection result of whether the object is a paper medium or a display screen. Thus, the reading device 10 according to the embodiment can quickly capture an image of a barcode or two-dimensional code printed on a paper medium or a barcode or two-dimensional code displayed on a display screen in a mode suitable for each.

That is, the reading device 10 according to the embodiment can efficiently read a symbol not only when reading a symbol printed on a paper medium but also when reading a symbol displayed on a display screen.

In addition, the reading device 10 according to the embodiment detects whether the object is a paper medium or a display screen according to brightness of a predetermined region in an image of an object captured by the image capturing unit 12. Therefore, whether the object is a paper medium or a display screen can be detected without adding hardware such as a camera for detection.

In addition, the reading device 10 according to the embodiment detects the emission intensity of the object, and changes the settings of the image capturing unit 12 according to the detected emission intensity to control the image capturing of the object. Therefore, according to the emission intensity of the display screen, an image of the object can be captured with the gain and shutter speed of the image capturing unit 12 corresponding to each state.

Further, the reading device 10 according to the embodiment controls to reduce the gain of the image capturing unit 12 to capture an image as the emission intensity of the object becomes stronger. Thus, an image can be captured with reduced sensitivity of the image capturing unit 12 when the emission intensity of the display screen is large, and an image can be captured with increased sensitivity of the image capturing unit 12 when the emission intensity of the display screen is small.

In addition, the reading device 10 according to the embodiment controls to increase the shutter speed of the image capturing unit 12 to capture an image as the emission intensity of the object becomes stronger. Thus, an image can be captured with reduced amount of light taken in when the emission intensity of the display screen is large, and an image can be captured with increased amount of light taken in when the emission intensity of the display screen is small.

The embodiment also can be appropriately modified and implemented by changing a part of the configuration or function of the reading device 10. Therefore, hereinafter, a modification relating to the embodiment will be described as another embodiment.

Hereinafter, differences from the embodiment will be mainly described, and detailed descriptions will be omitted with respect to similarities to the content already explained. Further, the modification described below may be implemented individually or in combination as appropriate.

(Modification)

In the above embodiment, an aspect in which the detecting unit 122 detects whether the object is a paper medium or a display screen according to the brightness of the predetermined region in the image of the object captured by the image capturing unit 12 is described. However, the detecting unit 122 may detect whether the object is a paper medium or a display screen based on the form of the object captured by the image capturing unit 12.

According to the modification, for example, the detecting unit 122 analyzes the image for detection acquired by the image acquiring unit 121 and recognizes the object in the image for detection. When features of the form of the object match predetermined features of the form of the mobile terminal or the like, the detecting unit 122 detects that the object is a display screen. On the other hand, when the features of the form of the object do not match the predetermined features of the form of the mobile terminal or the like, the detecting unit 122 detects that the object is a paper medium.

According to the modification, it is possible to prevent a situation in which the brightness value of an image including an object is erroneously detected due to light reflection or the like and whether the object is a paper medium or a display screen is erroneously detected.

A program executed by the reading device 10 according to the embodiment is provided by being incorporated in a storage medium (the ROM 104 or the storage unit 109) provided in the reading device 10 in advance, but the program is not limited to this, and the program may be provided by recording a file in an installable format or an executable format in a computer-readable recording medium such as a CD-ROM, a flexible disk (FD), a CD-R, or a digital versatile disk (DVD).

The storage medium is not limited to a medium independent of a computer or an embedded system, a storage medium in which a program transmitted via a LAN, the internet, or the like is downloaded and stored or temporarily stored is also included.

Further, the program executed by the reading device 10 according to the embodiment may be stored on a computer connected to a network such as the Internet, and provided by being downloaded via the network. In addition, the program executed in the reading device 10 according to the embodiment may be provided or distributed via a network such as the Internet.

While the embodiments of the disclosure have been described above, these embodiments have been presented by way of example only, and are not intended to limit the scope of the disclosures. These novel embodiments can be implemented in various other forms, and various omissions, substitutions, and modifications may be made without departing from the scope of the disclosures. The embodiments and the modification thereof are included in the scope and gist of the disclosures, and are included in the scope of disclosures disclosed in the scope of claims and equivalents of them.

What is claimed is:

1. A symbol reading device, comprising:
an image capturing component;
an illuminating component configured to illuminate an image capturing region of the image capturing component;
a detector configured to detect whether an object as an image capturing target is a non-light emitting medium or a light emitting medium based on an image captured by the image capturing component;
an illumination controller configured to control an operation of the illuminating component according to a detection result of the detector; and
a reading component configured to read a symbol from the image captured by the image capturing component.

2. The symbol reading device according to claim 1, wherein
the illumination controller is configured to operate the illuminating component in a first mode of irradiating the image capturing region with light when the object is the non-light emitting medium, and operate the illuminating component in a second mode in which a light amount of the light is lower than a light amount in the first mode when the object is the light emitting medium.

3. The symbol reading device according to claim 1, wherein
the detector is configured to detect whether the object is the non-light emitting medium or the light emitting medium according to a brightness of a predetermined region in an image of the object captured by the image capturing component.

4. The symbol reading device according to claim 1, further comprising:
an image capturing controller configured to control the image capturing component to capture an image of the object, wherein
the detector is configured to further detect an emission intensity of the object, and
the image capturing controller is configured to control capturing of the object by changing a setting of the image capturing component according to the emission intensity detected by the detector.

5. The symbol reading device according to claim 4, wherein
the image capturing controller is configured to perform at least one of a control of reducing a gain of the image capturing component to perform image capturing as the setting as the emission intensity becomes stronger, and a control of increasing a shutter speed of the image capturing component to perform image capturing as the setting as the emission intensity becomes stronger.

6. The symbol reading device according to claim 1, wherein
the detector determines whether the object is a paper medium or a display screen.

7. The symbol reading device according to claim 1, wherein
the detector detects whether the object is a paper medium or a display screen based on the image for detection acquired by the image capturing component.

8. A method for causing a computer to function as a symbol reading device including an image capturing component and an illuminating component configured to illuminate an image capturing region of the image capturing component, the method comprising:
detecting, by a detector, whether an object as an image capturing target is a non-light emitting medium or a light emitting medium based on an image captured by the image capturing component;
controlling, by an illumination controller, an operation of the illuminating component according to a detection result of the detector; and
reading, by a reading component, a symbol from the image captured by the image capturing component.

9. The method according to claim 8, wherein
the illumination controller is configured to operate the illuminating component in a first mode of irradiating the image capturing region with light when the object is the non-light emitting medium, and operate the illuminating component in a second mode in which a light amount of the light is lower than a light amount in the first mode when the object is the light emitting medium.

10. The method according to claim 8, wherein
the detector is configured to detect whether the object is the non-light emitting medium or the light emitting medium according to a brightness of a predetermined region in an image of the object captured by the image capturing component.

11. The method according to claim 8, further comprising:
an image capturing controller configured to control the image capturing component to capture an image of the object, wherein
the detector is configured to further detect an emission intensity of the object, and
the image capturing controller is configured to control capturing of the object by changing a setting of the image capturing component according to the emission intensity detected by the detector.

12. The method according to claim 11, wherein
the image capturing controller is configured to perform at least one of a control of reducing a gain of the image capturing component to perform image capturing as the setting as the emission intensity becomes stronger, and a control of increasing a shutter speed of the image capturing component to perform image capturing as the setting as the emission intensity becomes stronger.

13. The method according to claim 8, wherein
the detector determines whether the object is a paper medium or a display screen.

14. A point of sales terminal, comprising:
a registration processing device;
a settlement processing device; and
a symbol reading device, comprising:
an image capturing component;
an illuminating component configured to illuminate an image capturing region of the image capturing component;
a detector configured to detect whether an object as an image capturing target is a non-light emitting medium or a light emitting medium based on an image captured by the image capturing component;
an illumination controller configured to control an operation of the illuminating component according to a detection result of the detector; and
a reading component configured to read a symbol from the image captured by the image capturing component.

15. The point of sales terminal according to claim 14, wherein
the illumination controller is configured to operate the illuminating component in a first mode of irradiating the image capturing region with light when the object is the non-light emitting medium, and operate the illuminating component in a second mode in which a light amount of the light is lower than a light amount in the first mode when the object is the light emitting medium.

16. The point of sales terminal according to claim 14, wherein
the detector is configured to detect whether the object is the non-light emitting medium or the light emitting medium according to a brightness of a predetermined region in an image of the object captured by the image capturing component.

17. The point of sales terminal according to claim 14, further comprising:
an image capturing controller configured to control the image capturing component to capture an image of the object, wherein
the detector is configured to further detect an emission intensity of the object, and
the image capturing controller is configured to control capturing of the object by changing a setting of the image capturing component according to the emission intensity detected by the detector.

18. The point of sales terminal according to claim 17, wherein
the image capturing controller is configured to perform at least one of a control of reducing a gain of the image capturing component to perform image capturing as the setting as the emission intensity becomes stronger, and a control of increasing a shutter speed of the image capturing component to perform image capturing as the setting as the emission intensity becomes stronger.

19. The point of sales terminal according to claim 14, wherein
the detector determines whether the object is a paper medium or a display screen.

20. The point of sales terminal according to claim 14, wherein
the detector detects whether the object is a paper medium or a display screen based on the image for detection acquired by the image capturing component.
